(19) United States
(12) Patent Application Publication
(10) Pub. No.: US 2012/0148939 A1
(43) Pub. Date: Jun. 14, 2012

(54) ANION EXCHANGE MEMBRANE

(75) Inventors: Kazuya Yamamoto, Shiga (JP); Koji Yamada, Shiga (JP); Susumu Yamaguchi, Shiga (JP); Hirohisa Tanaka, Shiga (JP); Masaharu Asano, Takasaki-shi (JP); Tetsuya Yamaki, Takasaki-shi (JP); Hiroshi Koshikawa, Takasaki-shi (JP); Yasunari Maekawa, Maebashi-shi (JP); Warapon Sinananwanich, Amphur Maueng (TH)

(73) Assignee: JAPAN ATOMIC ENERGY AGENCY, Naka-gun (JP)

(21) Appl. No.: 13/288,190

(22) Filed: Nov. 3, 2011

(30) Foreign Application Priority Data
Dec. 9, 2010 (JP) 2010-274554

(51) Int. Cl. H01M 8/10

(52) U.S. Cl. 429/492

(57) ABSTRACT

An anion exchange membrane includes a quaternary ammonium salt group in which two methyl groups, and one alkyl group having 3 to 8 carbon atoms are bonded to a nitrogen atom.

### CROSS-REFERENCE TO RELATED APPLICATION

The present application claims priority from Japanese Patent Application No. 2010-274554 filed on Dec. 9, 2010, the contents of which are hereby incorporated by reference into this application.

### BACKGROUND OF THE INVENTION

1. Field of the Invention

The present invention relates to an anion exchange membrane, in particular, to an anion exchange membrane used for polymer electrolyte fuel cells and the like.

2. Description of Related Art

Recently, polymer electrolyte fuel cells are gaining attention as fuel cells for automobile use. Such a polymer electrolyte fuel cell generally includes, as an electrolyte layer, an ion exchange membrane composed of a polymer membrane.

An example of such an ion exchange membrane include an anion exchange membrane having a trimethylammonium group as an ion exchange group (e.g., Japanese Unexamined Patent Publication No. 2010-92660).

### SUMMARY OF THE INVENTION

However, when the anion exchange membrane described in Japanese Unexamined Patent Publication No. 2010-92660 is used for a long period of time in a polymer electrolyte fuel cell, there are disadvantages such as the following: the trimethylammonium group of the anion exchange membrane is gradually decomposed, and performance of the polymer electrolyte fuel cell is decreased.

Thus, the present invention provides an anion exchange membrane that can achieve improvement in durability while maintaining the membrane performance.

An anion exchange membrane of the present invention includes a quaternary ammonium salt group in which two methyl groups, and one alkyl group having 3 to 8 carbon atoms are bonded to a nitrogen atom.

In the anion exchange membrane of the present invention, it is preferable that the number of carbon atoms in the alkyl group is 4 to 6.

Furthermore, it is preferable that in the anion exchange membrane of the present invention, the quaternary ammonium salt group is bonded to a side chain branched from a main polymer chain.

An anion exchange membrane of the present invention includes a quaternary ammonium salt group in which two methyl groups, and one alkyl group having 3 to 8 carbon atoms are bonded to a nitrogen atom. Therefore, even if the anion exchange membrane is used for a long period of time, decomposition of the anion exchange membrane can be suppressed.

Thus, the anion exchange membrane of the present invention can achieve improvement in durability while maintaining membrane performance.

### DETAILED DESCRIPTION OF THE INVENTION

An anion exchange membrane of the present invention includes a quaternary ammonium salt group in which two methyl groups, and one alkyl group having 3 to 8 carbon atoms are bonded to a nitrogen atom.

Examples of alkyl groups having 3 to 8 carbon atoms include straight chain alkyl groups such as n-propyl, n-butyl, n-pentyl, n-hexyl, n-heptyl, and n-octyl; and branched alkyl groups such as isopropyl, isobutyl, sec-butyl, tert-butyl, isopentyl, sec-pentyl, isooctyl, and 2-ethylhexyl.

Of these alkyl groups, a preferable example is a straight chain alkyl group having 4 to 6 carbon atoms.

Examples of quaternary ammonium salt groups include quaternary ammonium salt groups in which two methyl groups, and one straight chain alkyl group having 3 to 8 carbon atoms are bonded to a nitrogen atom such as a dimethyl n-propyl ammonium group, a dimethyl n-butyl ammonium group, a dimethyl n-pentyl ammonium group, a dimethyl n-hexyl ammonium group, a dimethyl n-heptyl ammonium group, and a dimethyl n-octyl ammonium group; and quaternary ammonium salt groups in which two methyl groups, and one branched alkyl group having 3 to 8 carbon atoms are bonded to a nitrogen atom such as a dimethyl isopropyl ammonium group, a dimethyl isobutyl ammonium group, a dimethyl sec-butyl ammonium group, a dimethyl tert-butyl ammonium group, a dimethyl isopentyl ammonium group, a dimethyl sec-pentyl ammonium group, a dimethyl isooctyl ammonium group, and a dimethyl 2-ethylhexyl ammonium group.

Of these quaternary ammonium salt groups, preferable examples are a dimethyl n-butyl ammonium group and a dimethyl n-hexyl ammonium group.

Such an anion exchange membrane is produced by allowing a polymer membrane of a base component of the anion exchange membrane to react with a tertiary amine.

To produce such an anion exchange membrane, first, a polymer membrane of a base component of the anion exchange membrane is produced.

The polymer membrane of a base component of the anion exchange membrane is a polymer, to which a quaternary ammonium salt group can be introduced, formed into a membrane; and has an alkyl halide group as a functional group for introducing a quaternary ammonium salt group.

Examples of alkyl halide groups include alkyl chloride groups having 1 to 6 carbon atoms such as a chloromethyl group, a chloroethyl group, and a chloropropyl group; alkyl bromide groups having 1 to 6 carbon atoms such as a bromomethyl group, a bromoethyl group, and a bromopropyl group; and alkyl iodide groups having 1 to 6 carbon atoms such as an iodomethyl group, an iodoethyl group, and an iodobutyl group.

Of these alkyl halide groups, preferable examples are alkyl chloride groups having 1 to 6 carbon atoms, and more preferable examples are chloromethyl groups.

The polymer membrane is not particularly limited as long as the polymer membrane has an alkyl halide group, and examples of the polymer of the polymer membrane include linear copolymers such as a block copolymer and a random copolymer; and graft copolymers in which branched chains are bonded to the main polymer chain.

Of these polymers of the polymer membrane, a preferable example is a graft copolymer having an alkyl halide group in the branched chain.

To produce such a graft copolymer, for example, the following method may be used: a radical is generated by irradiating the main polymer chain with ionizing radiation such as an electron beam, and a monomer having an alkyl halide group is polymerized with the radical generation point as the polymerization initiation point.

To produce a graft copolymer having an alkyl halide group in its branched chain by such a method, first, a base material, which is obtained by forming a polymer chain for the main chain into a membrane, is prepared.

Examples of base materials include fluorinated copolymer membranes such as an ethylene-tetrafluoroethylene copolymer membrane (ETFE membrane), a polyvinylidene fluoride membrane (PVDF membrane), and a polytetrafluoroethylene membrane (PTFE membrane).

Of these base materials, a preferable example is an ethylene-tetrafluoroethylene copolymer membrane (ETFE membrane).

The base material has a membrane thickness of 10 to 150 μm, or preferably 30 to 60 μm.

For such a base material, for example, an ETFE membrane of a commercially available product (manufactured by Asahi Glass Co., Ltd.: membrane thickness 50 μm) can also be used.

Then, under an inert gas atmosphere such as argon, the base material is irradiated with γ-rays as an ionizing radiation, thereby allowing a polymerization initiation point to generate.

The absorbed dose of the γ-ray is, for example, 10 to 50 kGy, or preferably 10 to 40 kGy.

The irradiation conditions are as follows: the irradiation temperature of, for example, 5 to 50° C., or preferably 10 to 30° C., and the irradiation time of, for example, 60 to 120 min, or preferably 80 to 100 min.

Then, the monomer having an alkyl halide group is diluted with an organic solvent, preparing a monomer solution. Then, the base material in which the polymerization initiation point is generated is immersed in the monomer solution, allowing polymerization of the monomer with the polymerization initiation point of the base material as a branching point, thereby producing a graft copolymer having an alkyl halide group in the branched chain.

The monomer having an alkyl halide group may be a monomer having the above-described alkyl halide group, and examples thereof include vinyl monomers having an alkyl halide group such as chloromethylstyrene, chloroethylstyrene, chloropropylstyrene, bromomethylstyrene, bromoethylstyrene, bromopropylstyrene, allyl chloride, and allyl bromide.

Of these vinyl monomers having an alkyl halide group, a preferable example is chloromethylstyrene.

These vinyl monomers having an alkyl halide group may be used alone or in combination.

Examples of organic solvents include aromatic hydrocarbons such as benzene, toluene, xylene, and ethylbenzene; aliphatic hydrocarbons such as n-hexane, n-heptane, and n-octane; cyclic aliphatic hydrocarbons such as cyclohexane and methyl cyclohexane; alcohols such as methanol, ethanol, and isopropyl alcohol; ketones such as acetone, methyl ethyl ketone, diethylketone, and cyclohexanone; ethers such as diethylether, dioxane, and tetrahydrofuran; esters such as ethyl acetate and butyl acetate; and halogenated hydrocarbons such as methylene chloride, chloroform, 1, 2-dichloroethane, and chlorobenzene.

These organic solvents may be used alone or in combination.

Of these organic solvents, preferable examples are aromatic hydrocarbons.

The mixing ratio in the monomer solution (organic solvent: monomer having an alkyl halide group) is, for example, 2:1 to 1:2, or preferably 1.5:1 to 1:1.5.

The immersion conditions are as follows: the immersion temperature of, for example, 20 to 100° C., or preferably 40 to 80° C., and immersion time of, for example, 1 to 10 hours, or preferably 2 to 5 hours.

In a graft copolymer thus obtained, a monomer having an alkyl halide group is polymerized from the branching point of the base material while keeping the alkyl halide group, and therefore the graft copolymer has an alkyl halide group in its side chain branched from the main polymer chain thereof.

The graft copolymer has a graft rate of, for example, 25 to 100%, or preferably 30 to 80%.

The graft rate is a mass (in percentage) of the monomer having an alkyl halide group polymerized to the main polymer chain, relative to the mass of the base material, for example, an ETFE membrane.

Then, by allowing the polymer membrane of the base component of the anion exchange membrane to react with a tertiary amine, an anion exchange membrane having a quaternary ammonium salt group is produced.

To be more specific, first, a tertiary amine solution is prepared by dissolving a tertiary amine in a solvent, and a polymer membrane of the base component of the anion exchange membrane is immersed in the tertiary amine solution. This allows the alkyl halide group contained in the polymer membrane to react with the tertiary amine, and by replacing halogen atoms of the alkyl halide group with the tertiary amine, a quaternary ammonium salt group is introduced, thereby producing an anion exchange membrane.

Of these anion exchange membranes, a preferable example is an anion exchange membrane in which a quaternary ammonium salt group is bonded to the side chain branched from the main polymer chain.

Tertiary amines are amines having two methyl groups and one alkyl group having 3 to 8 carbon atoms both bonded to a nitrogen atom, and examples thereof include a tertiary amine including two methyl groups, and one straight chain alkyl group having 3 to 8 carbon atoms bonded to a nitrogen atom, such as dimethyl n-propylamine, dimethyl n-butylamine, dimethyl n-pentylamine, dimethyl n-hexylamine, dimethyl n-heptylamine, and dimethyl n-octylamine; and a tertiary amine including two methyl groups, and one branched alkyl group having 3 to 8 carbon atoms bonded to a nitrogen atom, such as dimethylisopropylamine, dimethylisobutylamine, dimethyl sec-butylamine, dimethyl tert-butylamine, dimethylisopentylamine, dimethyl sec-pentylamine, dimethylisooctylamine, and dimethyl 2-ethylhexylamine.

These tertiary amines may be used alone or in combination.

Of these tertiary amines, a preferable example is a tertiary amine having two methyl groups and a straight chain alkyl group having 4 to 6 carbon atoms bonded to a nitrogen atom, and more preferable examples are dimethyl n-butylamine and dimethyl n-hexylamine.

Examples of solvents include water, and alcohols such as methanol, ethanol, and propanol.

These solvents may be used alone or in combination.

Of these solvents, a preferable example is ethanol.

The tertiary amine solution has a concentration of, for example, 10 to 50 mass %, or preferably 20 to 40 mass %.

The immersion conditions are as follows: the immersion time of, for example, 2 to 48 hours, or preferably 24 to 48 hours, and the immersion temperature of, for example, 5 to 80° C., or preferably 10 to 40° C.

Then, as necessary, the produced anion exchange membrane is washed with pure water, and thereafter immersed in an acid solution or a solvent capable of dissolving tertiary amines, thereby removing excessive tertiary amines. Thereafter, the anion exchange membrane is washed with water again, and then dried in vacuum.

Examples of acid solutions include an inorganic aqueous acid solution of, for example, nitric acid, sulfuric acid, and hydrochloric acid; and an organic aqueous acid solution of, for example, formic acid and acetic acid.

These acid solutions may be used alone or in combination.

Of these acid solutions, a preferable example is an inorganic aqueous acid solution.

The acid solution has a concentration of, for example, 0.1 to 5 mol/L, or preferably 0.5 to 2 mol/L.

Examples of solvents capable of dissolving tertiary amines include ethanol, tetrahydrofuran (THF), toluene, and xylene.

These solvents may be used alone or in combination.

Of these solvents, preferable examples are solvents having a high polarity such as ethanol and THF.

The immersion time is, for example, 0.2 to 48 hours, or preferably 10 to 30 hours.

The anion exchange membrane thus produced has a quaternization rate of, for example, 70 to 100%, or preferably 80 to 100%.

The quaternization rate is the molarity (by percentage) of the tertiary amine introduced as the quaternary ammonium salt group relative to the molarity of the monomer having an alkyl halide group polymerized to the polymer chain.

The anion exchange membrane thus produced has a membrane thickness of, for example, 20 to 130 μm, or preferably 30 to 90 μm.

The anion exchange membrane thus produced has halogen ions as counterions of the quaternary ammonium salt group.

The halogen ions can be replaced appropriately with, for example, hydroxide ions and bicarbonate ions in accordance with the application of the anion exchange membrane. When the anion exchange membrane is used, for example, in polymer electrolyte fuel cells, halogen ions are replaced with hydroxide ions as counterions.

To replace halogen ions with hydroxide ions, for example, an anion exchange membrane having halogen ions as counterions is immersed in a basic solution, thereby replacing counterions of halogen ions with hydroxide ions.

Examples of basic solutions include aqueous solutions of, for example, sodium hydroxide and potassium hydroxide.

Of these basic solutions, a preferable example is an aqueous solution of potassium hydroxide.

The basic solution has a concentration of, for example, 0.1 to 5 mol/L, or preferably 0.5 to 3 mol/L.

These basic solutions may be used alone or in combination.

Immersion conditions are as follows: the immersion time of, for example, 5 to 24 hours, or preferably 10 to 15 hours, and the immersion temperature of, for example, 5 to 50° C., or preferably 10 to 30° C.

The anion exchange membrane having hydroxide ions as counterions has a water content of, for example, 10 to 70%, or preferably 30 to 60%.

To prepare an anion exchange membrane having bicarbonate ions as counterions, an anion exchange membrane having hydroxide ions as counterions is dried in air.

The drying time is, for example, 0.1 to 20 hours, or preferably 2 hours to 20 hours.

The anion exchange membrane having bicarbonate ions as counterions has an ion conductivity of, for example, 10 to 40 mS/cm, or preferably 20 to 40 mS/cm.

When a polymer electrolyte fuel cell including such an anion exchange membrane is used for a long period of time, OH radicals are generated inside the fuel cell, and problems such as a decrease in performance of the polymer electrolyte fuel cell may be caused due to the reaction of OH radicals with the anion exchange membrane.

However, the anion exchange membrane of the present invention contains a quaternary ammonium salt group including two methyl groups and one alkyl group having 3 to 8 carbon atoms both bonded to a nitrogen atom. Therefore, reaction of OH radicals with the anion exchange membrane is suppressed, which allows suppression of a decrease in performance of the polymer electrolyte fuel cell.

### EXAMPLES

While in the following, the present invention will be described in further detail with reference to Examples and Comparative Examples, the present invention is not limited to any of them.

### Example 1

An ETFE membrane (manufactured by Asahi Glass Co., Ltd.) having a membrane thickness of 50 μm was irradiated with a γ-ray (30 kGy) under an atmosphere of argon and at room temperature, and then immersed in a chloromethylstyrene (CMS)/xylene solution (chloromethylstyrene:xylene=1:1) at 60° C. for 2.5 hours, thereby producing a graft copolymer (graft rate 45%) having a chloromethyl group in a side chain branched from an ethylene-tetrafluoroethylene copolymer of a main chain.

Then, the obtained graft copolymer and a solution of 30 mass % dimethyl n-butylamine (DMBuA) in ethanol were introduced into a tube with screw cap, and the obtained graft copolymer was immersed in the solution while shaking using a shaker at room temperature for 48 hours (quaternization rate 90%).

Then, after washing with ultra pure water, the obtained graft copolymer was immersed in an 1M hydrochloric acid solution for 24 hours and washed, and thereafter, immersed in ultra pure water for 2 hours and washed, thereby producing an anion exchange membrane having halogen ions as counterions.

Then, after dried in vacuum, the obtained anion exchange membrane was immersed in an 1M potassium hydroxide solution for 10 hours to perform replacement of counterions, thereby producing an anion exchange membrane having hydroxide ions as counterions. Then, the obtained anion exchange membrane was dried in air for 12 hours, thereby producing an anion exchange membrane having bicarbonate ions as counterions.

### Example 2

An anion exchange membrane having bicarbonate ions as counterions was obtained in the same manner as in Example 1, except that a solution of 30 mass % dimethyl n-hexylamine (DMHeA) in ethanol was used instead of the solution of 30 mass % dimethyl n-butylamine (DMBuA) in ethanol. The graft rate of the graft copolymer was 45%, and the quaternization rate of the anion exchange membrane was 85%.

### Comparative Example 1

A anion exchange membrane having bicarbonate ions as counterions was obtained in the same manner as in Example 1, except that an aqueous solution of 30 mass % trimethylamine (TMA) was used instead of the solution of 30 mass % dimethyl n-butylamine (DMBuA) in ethanol, and the immersion was conducted for 2 hours. The graft rate of the graft copolymer was 45%, and the quaternization rate of the anion exchange membrane was 95%.

### Evaluation Test

Various measurements were conducted by the following methods.

In the measurements below, it is preferable that evaluation is done using an anion exchange membrane having hydroxide ions as counterions. However, because hydroxide ions rapidly react with carbon dioxide in air and transforms itself to bicarbonate ions, to obtain stable measurement values, an ion conductivity measurement and the Fenton's test were conducted using an anion exchange membrane having bicarbonate ions as counterions.

### 1. Ion Conductivity Measurement

The anion exchange membrane having bicarbonate ions as counterions obtained in the above-described Examples 1 and 2, and Comparative Example 1 was sandwiched with glass plates to which platinum electrodes were attached, held with a clip to achieve a constant torque, and then immersed in pure water adjusted to 60° C. Then, the impedance was measured using an impedance meter (manufactured by HIOKI, 3522-50 CHEMICAL IMPEDANCE METER). Because the impedance value decreases, the result was taken from the value after the elapse of 5 minutes, or from the minimum value before the elapse of 5 minutes. The above-described measurement result was regarded as the ion conductivity before the Fenton's test.

2. Fenton's test

An ion exchange water was added to 8.57 mL of an aqueous solution of hydrogen peroxide (H₂O₂), and then 0.0011 g of iron sulfate (FeSO₄) was added thereto, thereby producing a test solution having a total amount of 100 mL.

Then, the anion exchange membrane having bicarbonate ions as counterions obtained in Examples 1 and 2 and Comparative Example 1 was cut out to a size of 2×2 cm, and the anion membrane was immersed in the test solution.

Then, the test solution in which the anion membrane was immersed was introduced into a constant-temperature water tank set to 80° C., thereby generating OH radicals by the Fenton's reaction of chemical formula (1) below.

H₂O₂+Fe²⁺→Fe³⁺+OH⁻+.OH Chemical Formula (1)

Then, after 8 hours, the anion exchange membrane was taken out, and washed with water and dried.

After drying for one day in a low lint generation room, the ion conductivity after the Fenton's test was measured in the same manner as the above-described ion conductivity measurement.

The results are shown in Table 1.

TABLE 1

| | Ion conductivity | Ion conductivity | Ion Conductivity |
|---|---|---|---|
| | (Before Fenton's | (After Fenton's | Maintenance |
| | test) mS/cm | test) mS/cm | Rate % |
| Example 1 | 23.01 | 11.96 | 51.97 |
| Example 2 | 20.49 | 17.84 | 87.09 |
| Comp. Ex. 1 | 34.4 | 3.60 | 10.45 |

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

What is claimed is:

1. An anion exchange membrane comprising a quaternary ammonium salt group in which two methyl groups, and one alkyl group having 3 to 8 carbon atoms are bonded to a nitrogen atom.

2. The anion exchange membrane according to claim 1, wherein the number of carbon atoms in the alkyl group is 4 to 6.

3. The anion exchange membrane according to claim 1, wherein the quaternary ammonium salt group is bonded to a side chain branched from a main polymer chain.
